(19) United States
(12) Patent Application Publication
(10) Pub. No.: US 2006/0083389 A1
(43) Pub. Date: Apr. 20, 2006

(54) Speakerphone self calibration and beam forming

(76) Inventors: William V. Oxford, Austin, TX (US); Vijay Varadarajan, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/108,341

(22) Filed: Apr. 18, 2005

Related U.S. Application Data
(60) Provisional application No. 60/619,303, filed on Oct. 15, 2004.
(60) Provisional application No. 60/634,315, filed on Dec. 8, 2004.

(51) Int. Cl. H04R 3/00; H04R 1/02

(52) U.S. Cl. 381/92; 381/91; 381/122

(57) ABSTRACT

A communication system includes a set of microphones, a speaker, memory and a processor. The processor is configured to operate on input signals from the microphones to obtain a resultant signal representing the output of a virtual microphone which is highly directed in a target direction. The processor also is configured for self calibration. The processor may provide an output signal for transmission from the speaker. The output signal may be a noise signal, or, a portion of a live conversation. The processor captures one or more input signals in response to the output signal transmission uses the output signal and input signals to estimate parameters of the speaker and/or microphone.

### PRIORITY CLAIM

This application claims the benefit of priority to U.S. Provisional Application No. 60/619,303, filed on Oct. 15, 2004, entitled “Speakerphone”, invented by William V. Oxford, Michael L. Kenoyer and Simon Dudley, which is hereby incorporated by reference in its entirety.

This application claims the benefit of priority to U.S. Provisional Application No. 60/634,315, filed on Dec. 8, 2004, entitled “Speakerphone”, invented by William V. Oxford, Michael L. Kenoyer and Simon Dudley, which is hereby incorporated by reference in its entirety.

### BACKGROUND OF THE INVENTION

1. Field of the Invention

The present invention relates generally to the field of communication devices and, more specifically, to speakerphones.

2. Description of the Related Art

Speakerphones are used in many types of telephone calls, and particularly are used in conference calls where multiple people are located in a single room. A speakerphone may have a microphone to pick up voices of in-room participants, and, at least one speaker to audibly present voices from offsite participants. While speakerphones may allow several people to participate in a conference call on each end of the conference call, there are a number of problems associated with the use of speakerphones.

As the microphone and speaker age, their physical properties change, thus compromising the ability to perform high quality acoustic echo cancellation. Thus, there exists a need for a system and method capable of estimating descriptive parameters for the speaker and the microphone as they age.

Furthermore, noise sources such as fans, electrical appliances and air conditioning interfere with the ability to discern the voices of the conference participants. Thus, there exists a need for a system and method capable of “tuning in” on the voices of the conference participants and “tuning out” the noise sources.

### SUMMARY

In one set of embodiments, a system (e.g., a speakerphone or a videoconferencing system) may include a microphone, a speaker, memory and a processor. The memory may be configured to store program instructions and data. The processor is configured to read and execute the program instructions from the memory. The program instructions are executable by the processor to:
(a) output a stimulus signal for transmission from the speaker;
(b) receive an input signal from the microphone;
(c) compute a midrange sensitivity and a lowpass sensitivity for a spectrum of the input signal;
(d) subtract the midrange sensitivity from the lowpass sensitivity to obtain a speaker-related sensitivity;
(e) perform an iterative search for current values of parameters of an input-output model for the speaker using the input signal spectrum, a spectrum of the stimulus signal, the speaker-related sensitivity; and
(f) update averages of the parameters of the speaker input-output model using the current values obtained in (e).

The parameter averages of the speaker input-output model are usable to perform echo cancellation on other input signals.

The input-output model of the speaker may be a nonlinear model, e.g., a Volterra series model.

The stimulus signal may be a noise signal, e.g., a burst of maximum-length-sequence noise.

Furthermore, the program instructions may be executable by the processor to:
perform an iterative search for a current transfer function of the microphone using the input signal spectrum, the spectrum of the stimulus signal, and the current parameter values; and
update an average microphone transfer function using the current transfer function.

The average transfer function may also be usable to perform said echo cancellation on said other input signals.

In another set of embodiments, a method for performing self calibration may involve:
(a) outputting a stimulus signal (e.g., a noise signal) for transmission from a speaker;
(b) receiving an input signal from a microphone;
(c) computing a midrange sensitivity and a lowpass sensitivity for a spectrum of the input signal;
(d) subtracting the midrange sensitivity from the lowpass sensitivity to obtain a speaker-related sensitivity;
(e) performing an iterative search for current values of parameters of an input-output model for the speaker using the input signal spectrum, a spectrum of the stimulus signal, the speaker-related sensitivity; and
(f) updating averages of the parameters of the speaker input-output model using the current values obtained in (e).

The parameter averages of the speaker input-output model are usable to perform echo cancellation on other input signals.

The input-output model of the speaker may be a nonlinear model, e.g., a Volterra series model.

In yet another set of embodiments, a system (e.g., a speakerphone or a videoconferncing system) may include a microphone, a speaker, memory and a processor. The memory may be configured to store program instructions and data. The processor is configured to read and execute the program instructions from the memory. The program instructions are executable by the processor to:
(a) provide an output signal for transmission from the speaker, wherein the output signal carries live signal information from a remote source;
(b) receive an input signal from the microphone;
(c) compute a midrange sensitivity and a lowpass sensitivity for a spectrum of the input signal;
(d) subtract the midrange sensitivity from the lowpass sensitivity to obtain a speaker-related sensitivity;
(e) perform an iterative search for current values of parameters of an input-output model for the speaker using the input signal spectrum, a spectrum of the output signal, the speaker-related sensitivity; and
(f) update averages of the parameters of the speaker input-output model using the current values obtained in (e).

The parameter averages of the speaker input-output model are usable to perform echo cancellation on other input signals.

The input-output model of the speaker is a nonlinear model, e.g., a Volterra series model.

Furthermore, the program instructions may be executable by the processor to:
perform an iterative search for a current transfer function of the microphone using the input signal spectrum, the spectrum of the output signal, and the current parameter values; and
update an average microphone transfer function using the current transfer function.

The current transfer function is usable to perform said echo cancellation on said other input signals.

In yet another set of embodiments, a method for performing self calibration may involve:
(a) providing an output signal for transmission from a speaker, wherein the output signal carries live signal information from a remote source;
(b) receiving an input signal from a microphone;
(c) computing a midrange sensitivity and a lowpass sensitivity for a spectrum of the input signal;
(d) subtracting the midrange sensitivity from the lowpass sensitivity to obtain a speaker-related sensitivity;
(e) performing an iterative search for current values of parameters of an input-output model for the speaker using the input signal spectrum, a spectrum of the output signal, the speaker-related sensitivity; and
(f) updating averages of the parameters of the speaker input-output model using the current values obtained in (e).

The parameter averages of the speaker input-output model are usable to perform echo cancellation on other input signals.

Furthermore, the method may involve:
performing an iterative search for a current transfer function of the microphone using the input signal spectrum, the spectrum of the output signal, and the current values; and
updating an average microphone transfer function using the current transfer function.

The current transfer function is also usable to perform said echo cancellation on said other input signals.

In yet another set of embodiments, a system may include a set of microphones, memory and a processor. The memory is configured to store program instructions and data. The processor is configured to read and execute the program instructions from the memory. The program instructions are executable by the processor to:
(a) receive an input signal corresponding to each of the microphones;
(b) transform the input signals into the frequency domain to obtain respective input spectra;
(c) operate on the input spectra with a set of virtual beams to obtain respective beam-formed spectra, wherein each of the virtual beams is associated with a corresponding frequency range and a corresponding subset of the input spectra, wherein each of the virtual beams operates on portions of input spectra of the corresponding subset of input spectra which have been band limited to the corresponding frequency range, wherein the virtual beams include one or more low end beams and one or more high end beams, wherein each of the low end beams is a beam of a corresponding integer order, wherein each of the high end beams is a delay-and-sum beam;
(d) compute a linear combination of the beam-formed spectra to obtain a resultant spectrum; and
(e) inverse transform the resultant spectrum to obtain a resultant signal.

The program instructions are also executable by the processor to provide the resultant signal to a communication interface for transmission.

The set of microphones may be arranged in a circular array.

In yet another set of embodiments, a method for beam forming may involve:
(a) receiving an input signal from each microphone in set of microphones;
(b) transforming the input signals into the frequency domain to obtain respective input spectra;
(c) operating on the input spectra with a set of virtual beams to obtain respective beam-formed spectra, wherein each of the virtual beams is associated with a corresponding frequency range and a corresponding subset of the input spectra, wherein each of the virtual beams operates on portions of input spectra of the corresponding subset of input spectra which have been band limited to the corresponding frequency range, wherein the virtual beams include one or more low end beams and one or more high end beams, wherein each of the low end beams is a beam of a corresponding integer order, wherein each of the high end beams is a delay-and-sum beam;
(d) computing a linear combination of the beam-formed spectra to obtain a resultant spectrum; and
(e) inverse transforming the resultant spectrum to obtain a resultant signal.

The resultant signal may be provided to a communication interface for transmission (e.g., to a remote speakerphone).

The set of microphones may be arranged in a circular array.

In yet another set of embodiments, a system may include a set of microphones, memory and a processor. The memory is configured to store program instructions and data. The processor is configured to read and execute the program instructions from the memory. The program instructions are executable by the processor to:
(a) receive an input signal from each of the microphones;
(b) operate on the input signals with a set of virtual beams to obtain respective beam-formed signals, wherein each of the virtual beams is associated with a corresponding frequency range and a corresponding subset of the input signals, wherein each of the virtual beams operates on versions of the input signals of the corresponding subset of input signals which have been band limited to the corresponding frequency range, wherein the virtual beams include one or more low end beams and one or more high end beams, wherein each of the low end beams is a beam of a corresponding integer order, wherein each of the high end beams is a delay-and-sum beam; and
(c) compute a linear combination of the beam-formed signals to obtain a resultant signal.

The program instructions are executable by the processor to provide the resultant signal to a communication interface for transmission.

The set of microphones may be arranged in a circular array.

In yet another set of embodiments, a method for beam forming may involve:
(a) receiving an input signal from each microphone in a set of microphones;
(b) operating on the input signals with a set of virtual beams to obtain respective beam-formed signals, wherein each of the virtual beams is associated with a corresponding frequency range and a corresponding subset of the input signals, wherein each of the virtual beams operates on versions of the input signals of the corresponding subset of input signals which have been band limited to the corresponding frequency range, wherein the virtual beams include one or more low end beams and one or more high end beams, wherein each of the low end beams is a beam of a corresponding integer order, wherein each of the high end beams is a delay-and-sum beam; and
(c) computing a linear combination of the beam-formed signals to obtain a resultant signal.

The resultant signal may be provided to a communication interface for transmission (e.g., to a remote speakerphone).

The set of microphones are arranged in a circular array.

### BRIEF DESCRIPTION OF THE DRAWINGS

The following detailed description makes reference to the accompanying drawings, which are now briefly described.

FIG. 1 illustrates one set of embodiments of a speakerphone system 200.

FIG. 2 illustrates a direct path transmission and three examples of reflected path transmissions between the speaker 255 and microphone 201.

FIG. 3 illustrates a diaphragm of an electret microphone.

FIG. 4A illustrates the change over time of a microphone transfer function.

FIG. 4B illustrates the change over time of the overall transfer function due to changes in the properties of the speaker over time under the assumption of an ideal microphone.

FIG. 5 illustrates a lowpass weighting function L(ω).

FIG. 6A illustrates one set of embodiments of a method for performing offline self calibration.

FIG. 6B illustrates one set of embodiments of a method for performing “live” self calibration.

FIG. 7 illustrates one embodiment of speakerphone having a circular array of microphones.

FIG. 8 illustrates an example of design parameters associated with the design of a beam B(i).

FIG. 9 illustrates two sets of three microphones aligned approximately in a target direction, each set being used to form a virtual beam.

FIG. 10 illustrates three sets of two microphones aligned in a target direction, each set being used to form a virtual beam.

FIG. 11 illustrates two sets of four microphones aligned in a target direction, each set being used to form a virtual beam.

FIG. 12 illustrates one set of embodiments of a method for forming a hybrid beam.

FIG. 13 illustrates another set of embodiments of a method for forming a hybrid beam.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF THE PREFERRED EMBODIMENTS

List of Acronyms Used Herein

| | |
|---|---|
| DDR SDRAM = | Double-Data-Rate Synchronous Dynamic RAM |
| DRAM = | Dynamic RAM |
| FIFO = | First-In First-Out Buffer |
| FIR = | Finite Impulse Response |
| FFT = | Fast Fourier Transform |
| Hz = | Hertz |
| IIR = | Infinite Impulse Response |
| ISDN = | Integrated Services Digital Network |
| kHz = | kiloHertz |
| PSTN = | Public Switched Telephone Network |
| RAM = | Random Access Memory |
| RDRAM = | Rambus Dynamic RAM |
| ROM = | Read Only Memory |
| SDRAM = | Synchronous Dynamic Random Access Memory |
| SRAM = | Static RAM |

Speakerphone Block Diagram

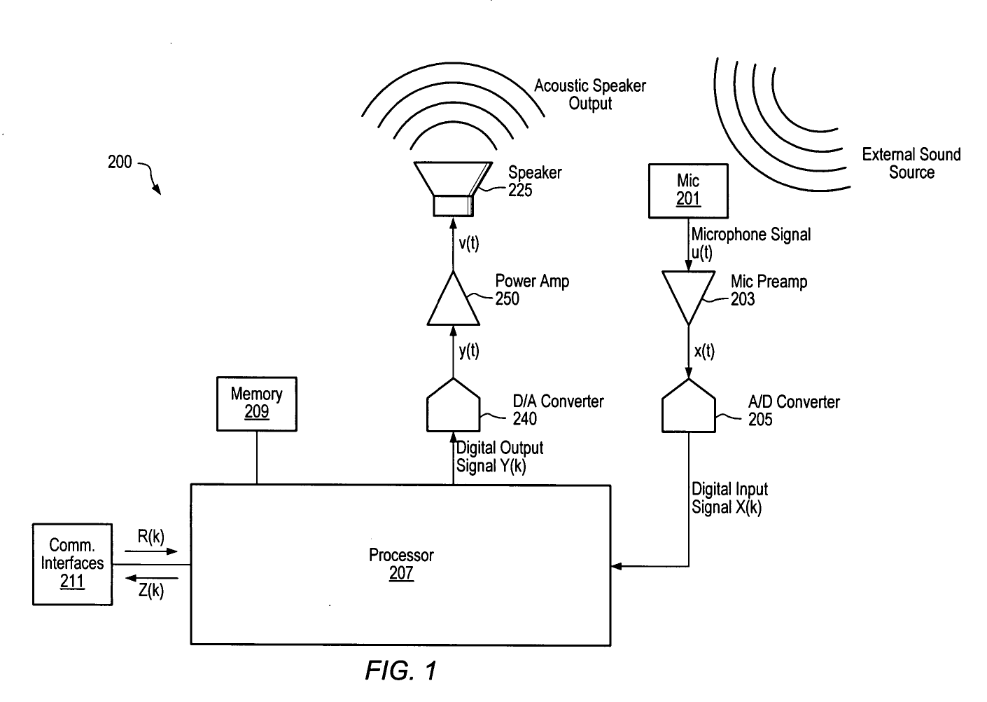

FIG. 1 illustrates a speakerphone 200 according to one set of embodiments. The speakerphone 200 may include a processor 207 (or a set of processors), memory 209, a set 211 of one or more communication interfaces, an input subsystem and an output subsystem.

The processor 207 is configured to read program instructions which have been stored in memory 209 and to execute the program instructions to execute any of the various methods described herein.

Memory 209 may include any of various kinds of semiconductor memory or combinations thereof. For example, in one embodiment, memory 209 may include a combination of Flash ROM and DDR SDRAM.

The input subsystem may include a microphone 201 (e.g., an electret microphone), a microphone preamplifier 203 and an analog-to-digital (A/D) converter 205. The microphone 201 receives an acoustic signal A(t) from the environment and converts the acoustic signal into an electrical signal u(t). (The variable t denotes time.) The microphone preamplifier 203 amplifies the electrical signal u(t) to produce an amplified signal x(t). The A/D converter samples the amplified signal x(t) to generate digital input signal X(k). The digital input signal X(k) is provided to processor 207.

In some embodiments, the A/D converter may be configured to sample the amplified signal x(t) at least at the Nyquist rate for speech signals. In other embodiments, the A/D converter may be configured to sample the amplified signal x(t) at least at the Nyquist rate for audio signals.

Processor 207 may operate on the digital input signal X(k) to remove various sources of noise, and thus, generate a corrected microphone signal Z(k). The processor 207 may send the corrected microphone signal Z(k) to one or more remote devices (e.g., a remote speakerphone) through one or more of the set 211 of communication interfaces.

The set 211 of communication interfaces may include a number of interfaces for communicating with other devices (e.g., computers or other speakerphones) through well-known communication media. For example, in various embodiments, the set 211 includes a network interface (e.g., an Ethernet bridge), an ISDN interface, a PSTN interface, or, any combination of these interfaces.

The speakerphone 200 may be configured to communicate with other speakerphones over a network (e.g., an Internet Protocol based network) using the network interface. In one embodiment, the speakerphone 200 is configured so multiple speakerphones, including speakerphone 200, may be coupled together in a daisy chain configuration.

The output subsystem may include a digital-to-analog (D/A) converter 240, a power amplifier 250 and a speaker 225. The processor 207 may provide a digital output signal Y(k) to the D/A converter 240. The D/A converter 240 converts the digital output signal Y(k) to an analog signal y(t). The power amplifier 250 amplifies the analog signal y(t) to generate an amplified signal v(t). The amplified signal v(t) drives the speaker 225. The speaker 225 generates an acoustic output signal in response to the amplified signal v(t).

Processor 207 may receive a remote audio signal R(k) from a remote speakerphone through one of the communication interfaces and mix the remote audio signal R(k) with any locally generated signals (e.g., beeps or tones) in order to generate the digital output signal Y(k). Thus, the acoustic signal radiated by speaker 225 may be a replica of the acoustic signals (e.g., voice signals) produced by remote conference participants situated near the remote speakerphone.

In one alternative embodiment, the speakerphone may include circuitry external to the processor 207 to perform the mixing of the remote audio signal R(k) with any locally generated signals.

In general, the digital input signal X(k) represents a superposition of contributions due to:
acoustic signals (e.g., voice signals) generated by one or more persons (e.g., conference participants) in the environment of the speakerphone 200, and reflections of these acoustic signals off of acoustically reflective surfaces in the environment;
acoustic signals generated by one or more noise sources (such as fans and motors, automobile traffic and fluorescent light fixtures) and reflections of these acoustic signals off of acoustically reflective surfaces in the environment; and
the acoustic signal generated by the speaker 225 and the reflections of this acoustic signal off of acoustically reflective surfaces in the environment.

Processor 207 may be configured to execute software including an automatic echo cancellation (AEC) module.

The AEC module attempts to estimate the sum C(k) of the contributions to the digital input signal X(k) due to the acoustic signal generated by the speaker and a number of its reflections, and, to subtract this sum C(k) from the digital input signal X(k) so that the corrected microphone signal Z(k) may be a higher quality representation of the acoustic signals generated by the conference participants.

In one set of embodiments, the AEC module may be configured to perform many (or all) of its operations in the frequency domain instead of in the time domain. Thus, the AEC module may:
estimate the Fourier spectrum C(ω) of the signal C(k) instead of the signal C(k) itself, and
subtract the spectrum C(ω) from the spectrum X(ω) of the input signal X(k) in order to obtain a spectrum Z(ω).

An inverse Fourier transform may be performed on the spectrum Z(ω) to obtain the corrected microphone signal Z(k). As used herein, the “spectrum” of a signal is the Fourier transform (e.g., the FFT) of the signal.

In order to estimate the spectrum C(ω), the AEC module may operate on:
the spectrum Y(ω) of a set of samples of the output signal Y(k),
the spectrum X(ω) of a set of samples of the input signal X(k), and
modeling information I_{M} describing the input-output behavior of the system elements (or combinations of system elements) between the circuit nodes corresponding to signals Y(k) and X(k).

For example, the modeling information IM may include:
(a) a gain of the D/A converter 240;
(b) a gain of the power amplifier 250;
(c) an input-output model for the speaker 225;
(d) parameters characterizing a transfer function for the direct path and reflected path transmissions between the output of speaker 225 and the input of microphone 201;
(e) a transfer function of the microphone 201;
(f) a gain of the preamplifier 203;
(g) a gain of the A/D converter 205.

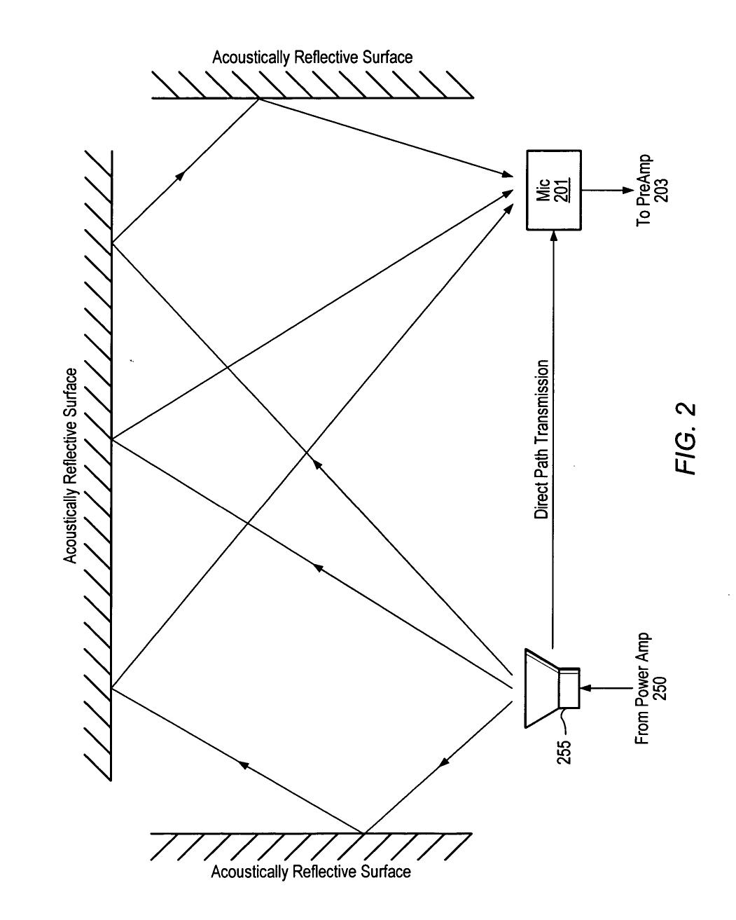

The parameters (d) may be (or may include) propagation delay times for the direct path transmission and a set of the reflected path transmissions between the output of speaker 225 and the input of microphone 201. FIG. 2 illustrates the direct path transmission and three reflected path transmission examples.

In some embodiments, the input-output model for the speaker may be (or may include) a nonlinear Volterra series model, e.g., a Volterra series model of the form:

$${f}_{S} ( k ) = {\sum }_{i = 0}^{{N}_{a} - 1} {a}_{i} v ( k - i ) + {\sum }_{i = 0}^{{N}_{b} - 1} {\sum }_{j = 0}^{{M}_{b} - 1} {b}_{ij} v ( k - i ) \cdot v ( k - j ) , \qquad ( 1 )$$

where v(k) represents a discrete-time version of the speaker's input signal, where fₛ(k) represents a discrete-time version of the speaker's acoustic output signal, where Nₐ, N_{b} and M_{b} are positive integers. For example, in one embodiment, Nₐ=8, N_{b}=3 and M_{b}=2. Expression (1) has the form of a quadratic polynomial. Other embodiments using higher order polynomials are contemplated.

In alternative embodiments, the input-output model for the speaker is a transfer function (or equivalently, an impulse response).

The AEC module may compute an update for the parameters (d) based on the output spectrum Y(ω), the input spectrum X(ω), and at least a subset of the modeling information I_{M} (possibly including previous values of the parameters (d)), and then, compute the compensation spectrum C(ω) using the output spectrum Y(ω) and the modeling information I_{M} (including the updated values of the parameters (d)).

In those embodiments where the speaker input-output model is a nonlinear model (such as a Volterra series model), the AEC module may be able to converge more quickly and/or achieve greater accuracy in its estimation of the direct path and reflected path delay times because it will have access to a more accurate representation of the actual acoustic output of the speaker than in those embodiments where linear model (e.g., transfer function) is used to model the speaker.

In some embodiments, the AEC module may employ one or more computational algorithms that are well known in the field of echo cancellation.

The modeling information I_{M} (or certain portions of the modeling information I_{M}) may be initially determined by measurements performed at a testing facility prior to sale or distribution of the speakerphone 200. Furthermore, certain portions of the modeling information I_{M} (e.g., those portions that are likely to change over time) may be repeatedly updated based on operations performed during the lifetime of the speakerphone 200.

In one embodiment, an update to the modeling information I_{M} may be based on samples of the input signal X(k) and samples of the output signal Y(k) captured during periods of time when the speakerphone is not being used to conduct a conversation.

In another embodiment, an update to the modeling information I_{M} may be based on samples of the input signal X(k) and samples of the output signal Y(k) captured while the speakerphone 200 is being used to conduct a conversation.

In yet another embodiment, both kinds of updates to the modeling information I_{M} may be performed.

Updating Modeling Information Based on Offline Calibration Experiments

In one set of embodiments, the processor 207 may be programmed to update the modeling information I_{M} during a period of time when the speakerphone 200 is not being used to conduct a conversation.

The processor 207 may wait for a period of relative silence in the acoustic environment. For example, if the average power in the input signal X(k) stays below a certain threshold for a certain minimum amount of time, the processor 207 may reckon that the acoustic environment is sufficiently silent for a calibration experiment. The calibration experiment may be performed as follows.

The processor 207 may output a known noise signal as the digital output signal Y(k). In some embodiments, the noise signal may be a burst of maximum-length-sequence noise, followed by a period of silence. For example, in one embodiment, the noise signal burst may be approximately 2-2.5 seconds long and the following silence period may be approximately 5 seconds long.

The processor 207 may capture a block B_{X} of samples of the digital input signal X(k) in response to the noise signal transmission. The block B_{X} may be sufficiently large to capture the response to the noise signal and a sufficient number of its reflections for a maximum expected room size.

The block B_{X} of samples may be stored into a temporary buffer, e.g., a buffer which has been allocated in memory 209.

The processor 207 computes a Fast Fourier Transform (FFT) of the captured block B_{X} of input signal samples X(k) and an FFT of a corresponding block B_{Y} of samples of the known noise signal Y(k), and computes an overall transfer function H(ω) for the current experiment according to the relation
H(ω)=FFT(B_{X})/FFT(B_{Y}), (2)
where ω denotes angular frequency. The processor may make special provisions to avoid division by zero.

The processor 207 may operate on the overall transfer function H(ω) to obtain a midrange sensitivity value s₁ as follows.

The midrange sensitivity value s₁ may be determined by computing an A-weighted average of the overall transfer function H(ω):
s₁=SUM[H(ω)A(ω), ω ranging from zero to 2π]. (3)

In some embodiments, the weighting function A(ω) may be designed so as to have low amplitudes:
at low frequencies where changes in the overall transfer function due to changes in the properties of the speaker are likely to be expressed, and
at high frequencies where changes in the overall transfer function due to material accumulation on the microphone diaphragm is likely to be expressed.

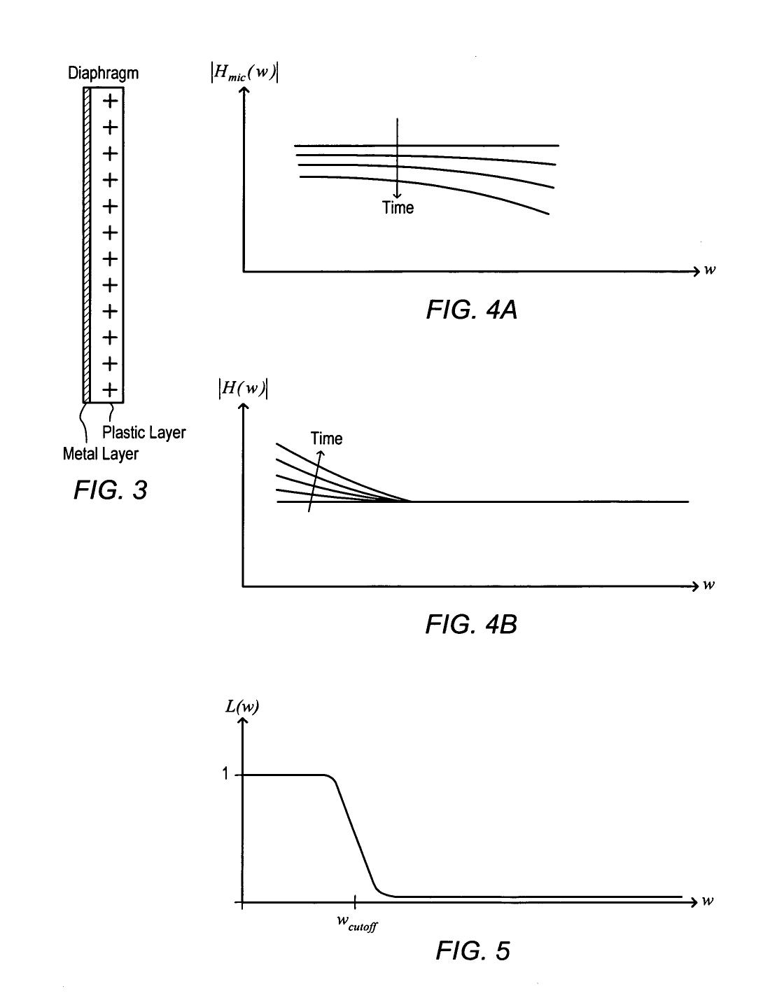

The diaphragm of an electret microphone is made of a flexible and electrically non-conductive material such as plastic (e.g., Mylar) as suggested in FIG. 3. Charge (e.g., positive charge) is deposited on one side of the diaphragm at the time of manufacture. A layer of metal may be deposited on the other side of the diaphragm.

As the microphone ages, the deposited charge slowly dissipates, resulting in a gradual loss of sensitivity over all frequencies. Furthermore, as the microphone ages material such as dust and smoke accumulates on the diaphragm, making it gradually less sensitive at high frequencies. The summation of the two effects implies that the amplitude of the microphone transfer function |H_{mic}(ω)| decreases at all frequencies, but decreases faster at high frequencies as suggested by FIG. 4A. If the speaker were ideal (i.e., did not change its properties over time), the overall transfer function H(ω) would manifest the same kind of changes over time.

The speaker 225 includes a cone and a surround coupling the cone to a frame. The surround is made of a flexible material such as butyl rubber. As the surround ages it becomes more compliant, and thus, the speaker makes larger excursions from its quiescent position in response to the same current stimulus. This effect is more pronounced at lower frequencies and negligible at high frequencies. In addition, the longer excursions at low frequencies implies that the vibrational mechanism of the speaker is driven further into the nonlinear regime. Thus, if the microphone were ideal (i.e., did not change its properties over time), the amplitude of the overall transfer function H(ω) in expression (2) would increase at low frequencies and remain stable at high frequencies, as suggested by FIG. 4B.

The actual change to the overall transfer function H(ω) over time is due to a combination of affects including the speaker aging mechanism and the microphone aging mechanism just described.

In addition to the sensitivity value s₁, the processor 207 may compute a lowpass sensitivity value s₂ and a speaker related sensitivity s₃ as follows. The lowpass sensitivity factor s₂ may be determined by computing a lowpass weighted average of the overall transfer function H(ω):
s₂=SUM[H(ω)L(ω), ω ranging from zero to 2π]. (4)

The lowpass weighting function L(ω) equals is equal (or approximately equal) to one at low frequencies and transitions towards zero in the neighborhood of a cutoff frequency. In one embodiment, the lowpass weighting function may smoothly transition to zero as suggested in FIG. 5.

The processor 207 may compute the speaker-related sensitivity value s₃ according to the expression:
s₃=s₂−s₁.

The processor 207 may maintain sensitivity averages S₁, S₂ and S₃ corresponding to the sensitivity values s₁, s₂ and s₃ respectively. The average Sᵢ, i=1, 2, 3, represents the average of the sensitivity value sᵢ from past performances of the calibration experiment.

Furthermore, processor 207 may maintain averages Aᵢ and Bᵢⱼ corresponding respectively to the coefficients aᵢ and bᵢⱼ in the Volterra series speaker model. After computing sensitivity value s₃, the processor may compute current estimates for the coefficients bᵢⱼ by performing an iterative search. Any of a wide variety of known search algorithms may be used to perform this iterative search.

In each iteration of the search, the processor may select values for the coefficients bᵢⱼ and then compute an estimated input signal X_{EST}(k) based on:
the block B_{Y} of samples of the transmitted noise signal Y(k);
the gain of the D/A converter 240 and the gain of the power amplifier 250;
the modified Volterra series expression

$${f}_{S} ( k ) = c {\sum }_{i = 0}^{{N}_{a} - 1} {A}_{i} v ( k - i ) + {\sum }_{i = 0}^{{N}_{b} - 1} {\sum }_{j = 0}^{{M}_{b} - 1} {b}_{ij} v ( k - i ) \cdot v ( k - j ) , \qquad ( 5 )$$
where c is given by c=s₃/S₃;
the parameters characterizing the transfer function for the direct path and reflected path transmissions between the output of speaker 225 and the input of microphone 201;
the transfer function of the microphone 201;
the gain of the preamplifier 203; and
the gain of the A/D converter 205.

The processor may compute the energy of the difference between the estimated input signal X_{EST}(k) and the block B_{X} of actually received input samples X(k). If the energy value is sufficiently small, the iterative search may terminate. If the energy value is not sufficiently small, the processor may select a new set of values for the coefficients bᵢⱼ, e.g., using knowledge of the energy values computed in the current iteration and one or more previous iterations.

The scaling of the linear terms in the modified Volterra series expression (5) by factor c serves to increase the probability of successful convergence of the bᵢⱼ.

After having obtained final values for the coefficients bᵢⱼ, the processor 207 may update the average values Bᵢⱼ according to the relations:
Bᵢⱼ←kᵢⱼBᵢⱼ+(1−kᵢⱼ)bᵢⱼ, (6)
where the values kᵢⱼ are positive constants between zero and one.

In one embodiment, the processor 207 may update the averages Aᵢ according to the relations:
Aᵢ←gᵢAᵢ+(1−gᵢ)(cAᵢ), (7)
where the values gᵢ are positive constants between zero and one.

In an alternative embodiment, the processor may compute current estimates for the Volterra series coefficients aᵢ based on another iterative search, this time using the Volterra expression:

$${f}_{S} ( k ) = {\sum }_{i = 0}^{{N}_{a} - 1} {a}_{i} v ( k - i ) + {\sum }_{i = 0}^{{N}_{b} - 1} {\sum }_{j = 0}^{{M}_{b} - 1} {B}_{ij} v ( k - i ) \cdot v ( k - j ) . \qquad ( 8 A )$$

After having obtained final values for the coefficients aᵢ, the processor may update the averages Aᵢ according the relations:
Aᵢ←gᵢAᵢ+(1−gᵢ)aᵢ. (8B)

The processor may then compute a current estimate T_{mic} of the microphone transfer function based on an iterative search, this time using the Volterra expression:

$${f}_{S} ( k ) = {\sum }_{i = 0}^{{N}_{a} - 1} {A}_{i} v ( k - i ) + {\sum }_{i = 0}^{{N}_{b} - 1} {\sum }_{j = 0}^{{M}_{b} - 1} {B}_{ij} v ( k - i ) \cdot v ( k - j ) . \qquad ( 9 )$$

After having obtained a current estimate T_{mic} for the microphone transfer function, the processor may update an average microphone transfer function H_{mic} based on the relation:
H_{mic}(ω)←kₘH_{mic}(ω)+(1−kₘ)T_{mic}(ω), (10)
where kₘ is a positive constant between zero and one.

Furthermore, the processor may update the average sensitivity values S₁, S₂ and S₃ based respectively on the currently computed sensitivities s₁, s₂, s₃, according to the relations:
S₁←h₁S₁+(1−h₁)s₁, (11)
S₂←h₂S₂+(1−h₂)s₂, (12)
S₃←h₃S₃+(1−h₃)s₃, (13)
where h₁, h₂, h₃ are positive constants between zero and one.

In the discussion above, the average sensitivity values, the Volterra coefficient averages Aᵢ and Bᵢⱼ and the average microphone transfer function H_{mic} are each updated according to an IIR filtering scheme. However, other filtering schemes are contemplated such as FIR filtering (at the expense of storing more past history data), various kinds of nonlinear filtering, etc.

In one set of embodiments, a system (e.g., a speakerphone or a videoconferencing system) may include a microphone, a speaker, memory and a processor, e.g., as illustrated in FIG. 1. The memory may be configured to store program instructions and data. The processor is configured to read and execute the program instructions from the memory. The program instructions are executable by the processor to:
(a) output a stimulus signal (e.g., a noise signal) for transmission from the speaker;
(b) receive an input signal from the microphone, corresponding to the stimulus signal and its reverb tail;
(c) compute a midrange sensitivity and a lowpass sensitivity for a spectrum of the input signal;
(d) subtract the midrange sensitivity from the lowpass sensitivity to obtain a speaker-related sensitivity;
(e) perform an iterative search for current values of parameters of an input-output model for the speaker using the input signal spectrum, a spectrum of the stimulus signal, the speaker-related sensitivity; and
(f) update averages of the parameters of the speaker input-output model using the current values obtained in (e).

The parameter averages of the speaker input-output model are usable to perform echo cancellation on other input signals.

The input-output model of the speaker may be a nonlinear model, e.g., a Volterra series model.

Furthermore, the program instructions may be executable by the processor to:
perform an iterative search for a current transfer function of the microphone using the input signal spectrum, the spectrum of the stimulus signal, and the current values; and
update an average microphone transfer function using the current transfer function.

The average transfer function is also usable to perform said echo cancellation on said other input signals.

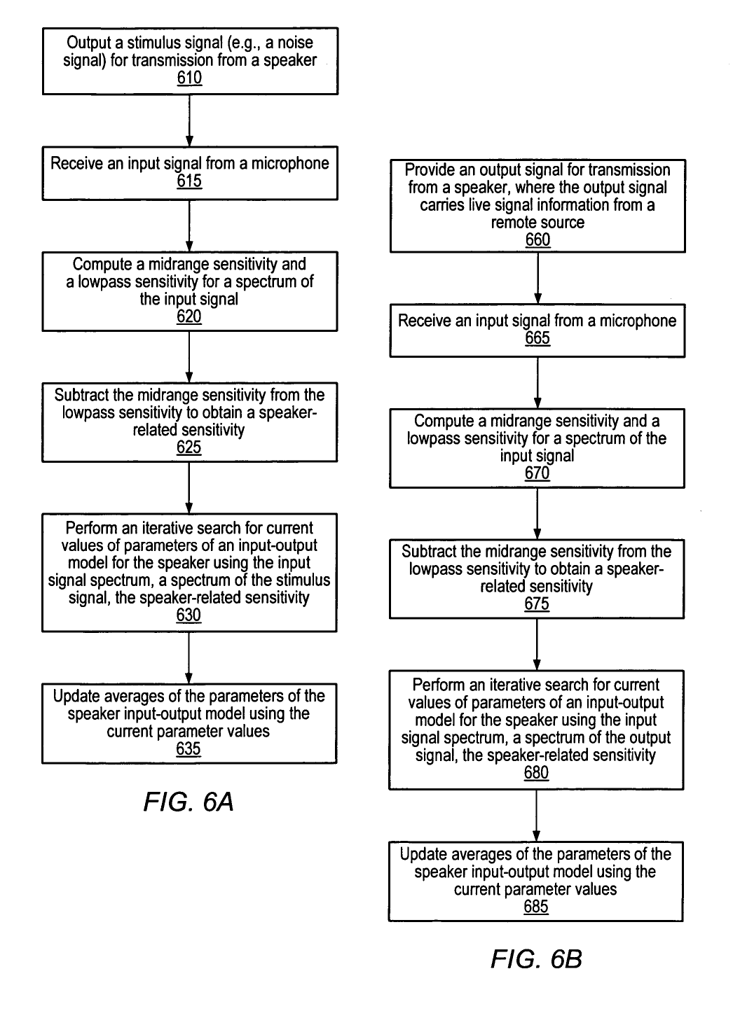

In another set of embodiments, as illustrated in FIG. 6A, a method for performing self calibration may involve the following steps:
(a) outputting a stimulus signal (e.g., a noise signal) for transmission from a speaker (as indicated at step 610);
(b) receiving an input signal from a microphone, corresponding to the stimulus signal and its reverb tail (as indicated at step 615);
(c) computing a midrange sensitivity and a lowpass sensitivity for a spectrum of the input signal (as indicated at step 620);
(d) subtracting the midrange sensitivity from the lowpass sensitivity to obtain a speaker-related sensitivity (as indicated at step 625);
(e) performing an iterative search for current values of parameters of an input-output model for the speaker using the input signal spectrum, a spectrum of the stimulus signal, the speaker-related sensitivity (as indicated at step 630); and
(f) updating averages of the parameters of the speaker input-output model using the current parameter values (as indicated at step 635).

The parameter averages of the speaker input-output model are usable to perform echo cancellation on other input signals.

The input-output model of the speaker may be a nonlinear model, e.g., a Volterra series model.

Updating Modeling Information Based on Online Data Gathering

In one set of embodiments, the processor 207 may be programmed to update the modeling information I_{M} during periods of time when the speakerphone 200 is being used to conduct a conversation.

Suppose speakerphone 200 is being used to conduct a conversation between one or more persons situated near the speakerphone 200 and one or more other persons situated near a remote speakerphone (or videoconferencing system). In this case, the processor 207 essentially sends out the remote audio signal R(k), provided by the remote speakerphone, as the digital output signal Y(k). It would probably be offensive to the local persons if the processor 207 interrupted the conversation to inject a noise transmission into the digital output stream Y(k) for the sake of self calibration. Thus, the processor 207 may perform its self calibration based on samples of the output signal Y(k) while it is “live”, i.e., carrying the audio information provided by the remote speakerphone. The self-calibration may be performed as follows.

The processor 207 may start storing samples of the output signal Y(k) into an first FIFO and storing samples of the input signal X(k) into a second FIFO, e.g., FIFOs allocated in memory 209. Furthermore, the processor may scan the samples of the output signal Y(k) to determine when the average power of the output signal Y(k) exceeds (or at least reaches) a certain power threshold. The processor 207 may terminate the storage of the output samples Y(k) into the first FIFO in response to this power condition being satisfied. However, the processor may delay the termination of storage of the input samples X(k) into the second FIFO to allow sufficient time for the capture of a full reverb tail corresponding to the output signal Y(k) for a maximum expected room size.

The processor 207 may then operate, as described above, on a block B_{Y} of output samples stored in the first FIFO and a block B_{X} of input samples stored in the second FIFO to compute:
(1) current estimates for Volterra coefficients aᵢ and bᵢⱼ;
(2) a current estimate T_{mic} for the microphone transfer function;
(3) updates for the average Volterra coefficients Aᵢ and Bᵢⱼ; and
(4) updates for the average microphone transfer function H_{mic}.

Because the block B_{X} of received input sample is captured while the speakerphone 200 is being used to conduct a live conversation, the block B_{X} is very likely to contain interference (from the point of view of the self calibration) due to the voices of persons in the environment of the microphone 201. Thus, in updating the average values with the respective current estimates, the processor may strongly weight the past history contribution, i.e., much more strongly than in those situations described above where the self-calibration is performed during periods of silence in the external environment.

In some embodiments, a system (e.g., a speakerphone or a videoconferencing system) may include a microphone, a speaker, memory and a processor, e.g., as illustrated in FIG. 1. The memory may be configured to store program instructions and data. The processor is configured to read and execute the program instructions from the memory. The program instructions are executable by the processor to:
(a) provide an output signal for transmission from the speaker, wherein the output signal carries live signal information from a remote source;
(b) receive an input signal from the microphone, corresponding to the output signal and its reverb tail;
(c) compute a midrange sensitivity and a lowpass sensitivity for a spectrum of the input signal;
(d) subtract the midrange sensitivity from the lowpass sensitivity to obtain a speaker-related sensitivity;
(e) perform an iterative search for current values of parameters of an input-output model for the speaker using the input signal spectrum, a spectrum of the output signal, the speaker-related sensitivity; and
(f) update averages of the parameters of the speaker input-output model using the current values obtained in (e).

The parameter averages of the speaker input-output model are usable to perform echo cancellation on other input signals.

The input-output model of the speaker is a nonlinear model, e.g., a Volterra series model.

Furthermore, the program instructions may be executable by the processor to:
perform an iterative search for a current transfer function of the microphone using the input signal spectrum, the spectrum of the output signal, and the current values; and
update an average microphone transfer function using the current transfer function.

The current transfer function is usable to perform said echo cancellation on said other input signals.

In one set of embodiments, as illustrated in FIG. 6B, a method for performing self calibration may involve:
(a) providing an output signal for transmission from a speaker, wherein the output signal carries live signal information from a remote source (as indicated at step 660);
(b) receiving an input signal from a microphone, corresponding to the output signal and its reverb tail (as indicated at step 665);
(c) computing a midrange sensitivity and a lowpass sensitivity for a spectrum of the input signal (as indicated at step 670);
(d) subtracting the midrange sensitivity from the lowpass sensitivity to obtain a speaker-related sensitivity (as indicated at step 675);
(e) performing an iterative search for current values of parameters of an input-output model for the speaker using the input signal spectrum, a spectrum of the output signal, the speaker-related sensitivity (as indicated at step 680); and
(f) updating averages of the parameters of the speaker input-output model using the current parameter values (as indicated at step 685).

The parameter averages of the speaker input-output model are usable to perform echo cancellation on other input signals.

Furthermore, the method may involve:
performing an iterative search for a current transfer function of the microphone using the input signal spectrum, the spectrum of the output signal, and the current values; and
updating an average microphone transfer function using the current transfer function.

The current transfer function is also usable to perform said echo cancellation on said other input signals.

Plurality of Microphones

In some embodiments, the speakerphone 200 may include N_{M} input channels, where N_{M} is two or greater. Each input channel ICⱼ, j=1, 2, 3, . . . , N_{M} may include a microphone Mⱼ, a preamplifier PAⱼ, and an A/D converter ADCⱼ. The description given above of various embodiments in the context of one input channel naturally generalizes to N_{M} input channels.

Let uⱼ(t) denote the analog electrical signal captured by microphone Mⱼ.

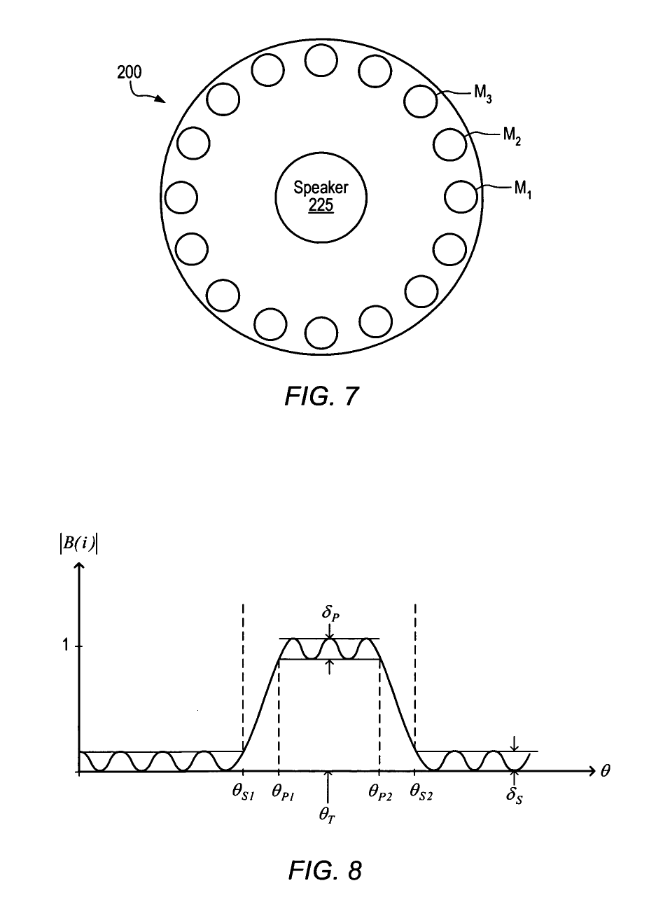

In one group of embodiments, the N_{M} microphones may be arranged in a circular array with the speaker 225 situated at the center of the circle as suggested by the physical realization (viewed from above) illustrated in FIG. 7. Thus, the delay time τ₀ of the direct path transmission between the speaker and each microphone is approximately the same for all microphones. In one embodiment of this group, the microphones may all be omni-directional microphones having approximately the same transfer function. In this embodiment, the speakerphone 200 may apply the same correction signal e(t) to each microphone signal uⱼ(t): rⱼ(t)=uⱼ(t)−e(t) for j=1, 2, 3, . . . , N_{M}. The use of omni-directional microphones makes it much easier to achieve (or approximate) the condition of approximately equal microphone transfer functions.

Preamplifier PAⱼ amplifies the difference signal rⱼ(t) to generate an amplified signal xⱼ(t). ADCⱼ samples the amplified signal xⱼ(t) to obtain a digital input signal Xⱼ(k).

Processor 207 may receive the digital input signals Xⱼ(k), j=1, 2, . . . , N_{M}.

In one embodiment, N_{M} equals 16. However, a wide variety of other values are contemplated for N_{M}.

Hybrid Beamforming

In one set of embodiments, processor 207 may operate on the set of digital input signals Xⱼ(k), j=1, 2, . . . , N_{M} to generate a resultant signal D(k) that represents the output of a highly directional virtual microphone pointed in a target direction. The virtual microphone is configured to be much more sensitive in an angular neighborhood of the target direction than outside this angular neighborhood. The virtual microphone allows the speakerphone to “tune in” on any acoustic sources in the angular neighborhood and to “tune out” (or suppress) acoustic sources outside the angular neighborhood.

According to one methodology, the processor 207 may generate the resultant signal D(k) by:
computing a Fourier transform of the digital input signals Xⱼ(k), j=1, 2, . . . , N_{M}, to generate corresponding input spectra Xⱼ(f), j=1, 2, . . . , N_{M}, where f denotes frequency; and
operating on the input spectra Xⱼ(f), j=1, 2, . . . , N_{M} with virtual beams B(1), B(2), . . . , B(N_{B}) to obtain respective beam formed spectra V(1), V(2), . . . , V(N_{B}), where N_{B} is greater than or equal to two;
adding (perhaps with weighting) the spectra V(1), V(2), . . . , V(N_{B}) to obtain a resultant spectrum D(f);
inverse transforming the resultant spectrum D(f) to obtain the resultant signal D(k).

Each of the virtual beams B(i), i=1, 2, . . . , N_{B} has an associated frequency range
R(i)=[cᵢ,dᵢ]
and operates on a corresponding subset Sᵢ of the input spectra Xⱼ(f), j=1, 2, . . . , N_{M}. (To say that A is a subset of B does not exclude the possibility that subset A may equal set B.) The processor 207 may window each of the spectra of the subset Sᵢ with a window function Wᵢ corresponding to the frequency range R(i) to obtain windowed spectra, and, operate on the windowed spectra with the beam B(i) to obtain spectrum V(i). The window function Wᵢ may equal one inside the range R(i) and the value zero outside the range R(i). Alternatively, the window function Wᵢ may smoothly transition to zero in neighborhoods of boundary frequencies cᵢ and dᵢ.

The union of the ranges R(1), R(2), . . . , R(N_{B}) may cover the range of audio frequencies, or, at least the range of frequencies occurring in speech.

The ranges R(1), R(2), . . . , R(N_{B}) includes a first subset of ranges that are above a certain frequency f_{TR} and a second subset of ranges that are below the frequency f_{TR}. For example, in one embodiment, the frequency f_{TR} may be approximately 550 Hz.

Each of the virtual beams B(i) that corresponds to a frequency range R(i) below the frequency f_{TR} may be a beam of order L(i) formed from L(i)+1 of the input spectra Xⱼ(f), j=1, 2, . . . , N_{M}, where L(i) is an integer greater than or equal to one. The L(i)+1 spectra may correspond to L(i)+1 microphones of the circular array that are aligned (or approximately aligned) in the target direction.

Furthermore, each of the virtual beams B(i) that corresponds to a frequency range R(i) above the frequency f_{TR} may have the form of a delay-and-sum beam. The delay-and-sum parameters of the virtual beam B(i) may be designed by beam forming design software. The beam forming design software may be conventional software known to those skilled in the art of beam forming. For example, the beam forming design software may be software that is available as part of MATLAB®.

The beam forming design software may be directed to design an optimal delay-and-sum beam for beam B(i) at some frequency (e.g., the midpoint frequency) in the frequency range R(i) given the geometry of the circular array and beam constraints such as passband ripple δ_{P}, stopband ripple δ_{S}, passband edges θ_{P1} and θ_{P2}, first stopband edge θ_{S1} and second stopband edge θ_{S2} as suggested by FIG. 8.

The beams corresponding to frequency ranges above the frequency f_{TR} are referred to herein as “high end” beams. The beams corresponding to frequency ranges below the frequency f_{TR} are referred to herein as “low end” beams. The virtual beams B(1), B(2), . . . , B(N_{B}) may include one or more low end beams and one or more high end beams.

In some embodiments, the beam constraints may be the same for all high end beams B(i). The passband edges θ_{P1} and θ_{P2} may be selected so as to define an angular sector of size 360/N_{M} degrees (or approximately this size). The passband may be centered on the target direction θ_{T}.

The delay-and-sum parameters for each high end beam and the parameters for each low end beam may be designed at a laboratory facility and stored into memory 209 prior to operation of the speakerphone 200. Since the microphone array is symmetric with respect to rotation through any multiple of 360/N_{M} degrees, the set of parameters designed for one target direction may be used for any of the N_{M} target directions given by k(360/N_{M}), k=0, 1, 2, . . . , N_{M}−1.

In one embodiment,
the frequency f_{TR} is 550 Hz,
R(1)=R(2)=[0,550 Hz],
L(1)=L(2)=2, and
low end beam B(1) operates on three of the spectra Xⱼ(f), j=1, 2, . . . , N_{M}, and low end beam B(2) operates on a different three of the spectra Xⱼ(f), j=1, 2, . . . , N_{M};
frequency ranges R(3), R(4), . . . , R(N_{B}) are an ordered succession of ranges covering the frequencies from f_{TR} up to a certain maximum frequency (e.g., the upper limit of audio frequencies, or, the upper limit of voice frequencies);
beams B(3), B(4), . . . , B(N_{M}) are high end beams designed as described above.

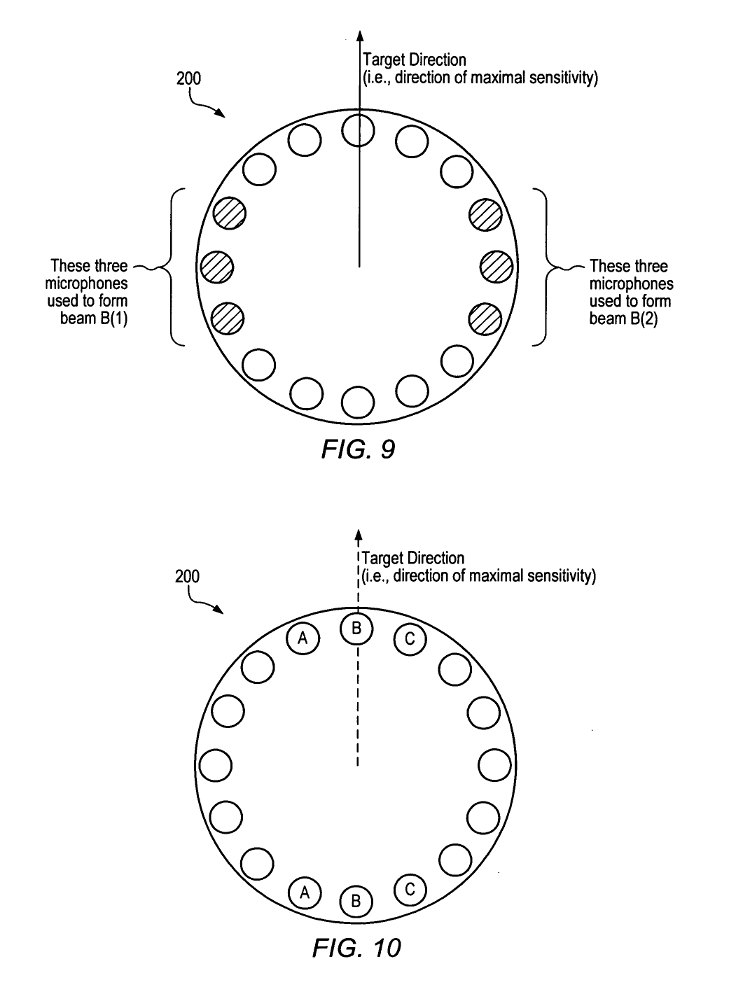

FIG. 9 illustrates the three microphones (and thus, the three spectra) used by each of beams B(1) and B(2), relative to the target direction.

In another embodiment, the virtual beams B(1), B(2), . . . , B(N_{B}) may include a set of low end beams of first order. FIG. 10 illustrates an example of three low end beams of first order. Each of the three low end beams may be formed using a pair of the input spectra Xⱼ(f), j=1, 2, . . . , N_{M}. For example, beam B(1) may be formed from the input spectra corresponding to the two “A” microphones. Beam B(2) may be formed form the input spectra corresponding to the two “B” microphones. Beam B(3) may be formed form the input spectra corresponding to the two “C” microphones.

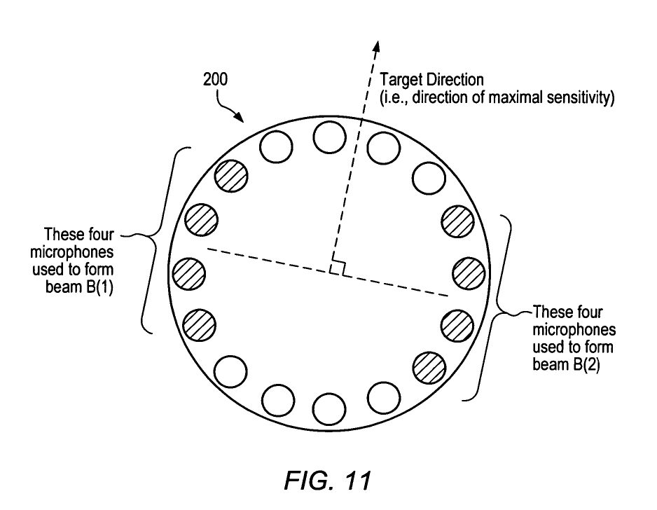

In yet another embodiment, the virtual beams B(1), B(2), . . . , B(N_{B}) may include a set of low end beams of third order. FIG. 11 illustrates an example of two low end beams of third order. Each of the two low end beams may be formed using a set of four input spectra corresponding to four consecutive microphone channels that are approximately aligned in the target direction.

In one embodiment, the low order beams may include:
second order beams (e.g., a pair of second order beams as suggested in FIG. 9), each second order beam being associated with the range of frequencies less than f₁, where f₁ is less than f_{TR}; and
third order beams (e.g., a pair of third order beams as suggested in FIG. 11), each third order beam being associated with the range of frequencies from f₁ to f_{TR}.

For example, f₁ may equal approximately 250 Hz.

In some embodiments, a system (e.g., a speakerphone or a videoconferencing system) may include a set of microphones, memory and a processor, e.g., as suggested in FIG. 1 and FIG. 7. The memory is configured to store program instructions and data. The processor is configured to read and execute the program instructions from the memory. The program instructions are executable by the processor to:
(a) receive an input signal corresponding to each of the microphones;
(b) transform the input signals into the frequency domain to obtain respective input spectra;
(c) operate on the input spectra with a set of virtual beams to obtain respective beam-formed spectra, wherein each of the virtual beams is associated with a corresponding frequency range and a corresponding subset of the input spectra, wherein each of the virtual beams operates on portions of input spectra of the corresponding subset of input spectra which have been band limited to the corresponding frequency range, wherein the virtual beams include one or more low end beams and one or more high end beams, wherein each of the low end beams is a beam of a corresponding integer order, wherein each of the high end beams is a delay-and-sum beam;
(d) compute a linear combination (e.g., a sum or a weighted sum) of the beam-formed spectra to obtain a resultant spectrum; and
(e) inverse transform the resultant spectrum to obtain a resultant signal.

The program instructions are also executable by the processor to provide the resultant signal to a communication interface for transmission.

The set of microphones may be arranged in a circular array.

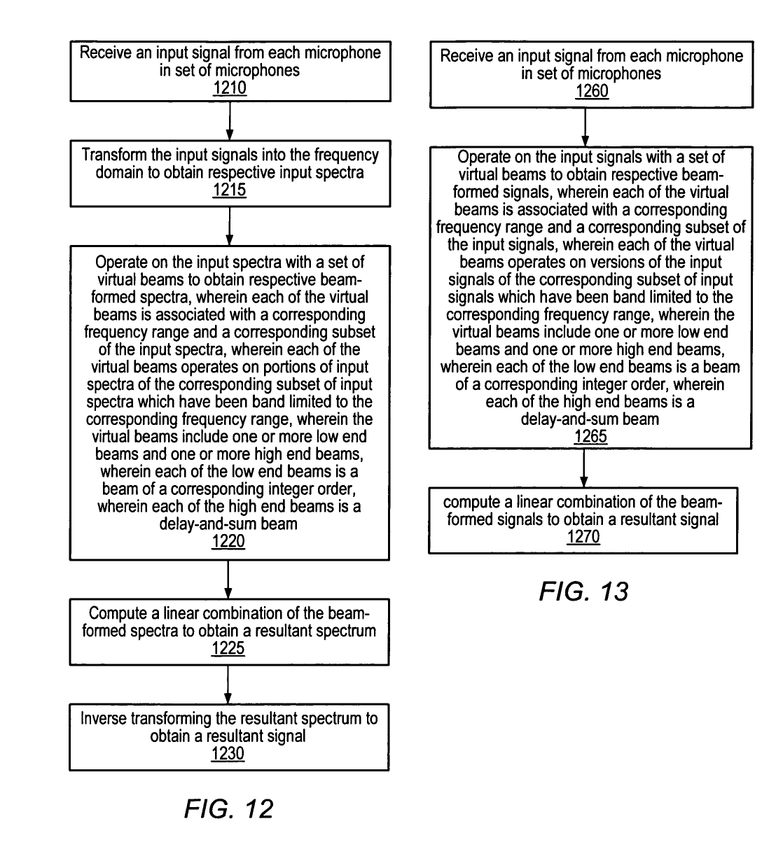

In another set of embodiments, as illustrated in FIG. 12, a method for beam forming may involve:
(a) receiving an input signal from each microphone in set of microphones (as indicated at step 1210);
(b) transforming the input signals into the frequency domain to obtain respective input spectra (as indicated at step 1215);
(c) operating on the input spectra with a set of virtual beams to obtain respective beam-formed spectra, wherein each of the virtual beams is associated with a corresponding frequency range and a corresponding subset of the input spectra, wherein each of the virtual beams operates on portions of input spectra of the corresponding subset of input spectra which have been band limited to the corresponding frequency range, wherein the virtual beams include one or more low end beams and one or more high end beams, wherein each of the low end beams is a beam of a corresponding integer order, wherein each of the high end beams is a delay-and-sum beam (as indicated at step 1220);
(d) computing a linear combination (e.g., a sum or a weighted sum) of the beam-formed spectra to obtain a resultant spectrum (as indicated at step 1225); and
(e) inverse transforming the resultant spectrum to obtain a resultant signal (as indicated at step 1230).

The resultant signal may be provided to a communication interface for transmission (e.g., to a remote speakerphone).

The set of microphones may be arranged in a circular array.

The high end beams may be designed using beam forming design software. Each of the high end beams may be designed subject to the same (or similar) beam constraints. For example, each of the high end beams may be constrained to have the same pass band width (i.e., main lobe width).

In yet another set of embodiments, a system may include a set of microphones, memory and a processor, e.g., as suggested in FIG. 1 and FIG. 7. The memory is configured to store program instructions and data. The processor is configured to read and execute the program instructions from the memory. The program instructions are executable by the processor to:
(a) receive an input signal from each of the microphones;
(b) operate on the input signals with a set of virtual beams to obtain respective beam-formed signals, wherein each of the virtual beams is associated with a corresponding frequency range and a corresponding subset of the input signals, wherein each of the virtual beams operates on versions of the input signals of the corresponding subset of input signals which have been band limited to the corresponding frequency range, wherein the virtual beams include one or more low end beams and one or more high end beams, wherein each of the low end beams is a beam of a corresponding integer order, wherein each of the high end beams is a delay-and-sum beam; and
(c) compute a linear combination (e.g., a sum or a weighted sum) of the beam-formed signals to obtain a resultant signal.

The program instructions are executable by the processor to provide the resultant signal to a communication interface for transmission.

The set of microphones may be arranged in a circular array.

In yet another set of embodiments, as illustrated in FIG. 13, a method for beam forming may involve:
(a) receiving an input signal from each microphone in a set of microphones;
(b) operating on the input signals with a set of virtual beams to obtain respective beam-formed signals, wherein each of the virtual beams is associated with a corresponding frequency range and a corresponding subset of the input signals, wherein each of the virtual beams operates on versions of the input signals of the corresponding subset of input signals which have been band limited to the corresponding frequency range, wherein the virtual beams include one or more low end beams and one or more high end beams, wherein each of the low end beams is a beam of a corresponding integer order, wherein each of the high end beams is a delay-and-sum beam; and
(c) computing a linear combination (e.g., a sum or a weighted sum) of the beam-formed signals to obtain a resultant signal.

The resultant signal may be provided to a communication interface for transmission (e.g., to a remote speakerphone).

The set of microphones are arranged in a circular array.

The high end beams may be designed using beam forming design software. Each of the high end beams may be designed subject to the same (or similar) beam constraints. For example, each of the high end beams may be constrained to have the same pass band width (i.e., main lobe width).

### CONCLUSION

Various embodiments may further include receiving, sending or storing program instructions and/or data implemented in accordance with the foregoing description upon a computer-accessible medium. Generally speaking, a computer-accessible medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system comprising:
a set of microphones;
memory configured to store program instructions;
a processor configured to read and execute the program instructions from the memory, wherein the program instructions are executable by the processor to:
(a) receive an input signal corresponding to each of the microphones;
(b) transform the input signals into the frequency domain to obtain respective input spectra;
(c) operate on the input spectra with a set of virtual beams to obtain respective beam-formed spectra, wherein each of the virtual beams is associated with a corresponding frequency range and a corresponding subset of the input spectra, wherein each of the virtual beams operates on portions of input spectra of the corresponding subset of input spectra which have been band limited to the corresponding frequency range, wherein the virtual beams include one or more low end beams and one or more high end beams, wherein each of the low end beams is a beam of a corresponding integer order, wherein each of the high end beams is a delay-and-sum beam;
(d) compute a linear combination of the beam-formed spectra to obtain a resultant spectrum; and
(e) inverse transform the resultant spectrum to obtain a resultant signal.

2. The system of claim 1, wherein the program instructions further executable by the processor to provide the resultant signal to a communication interface for transmission.

3. The system of claim 1, wherein the set of microphones are arranged in a circular array.

4. A system comprising:
a set of microphones;
memory configured to store program instructions;
a processor configured to read and execute the program instructions from the memory, wherein the program instructions are executable by the processor to:
(a) receive an input signal from each of the microphones;
(b) operate on the input signals with a set of virtual beams to obtain respective beam-formed signals, wherein each of the virtual beams is associated with a corresponding frequency range and a corresponding subset of the input signals, wherein each of the virtual beams operates on versions of the input signals of the corresponding subset of input signals which have been band limited to the corresponding frequency range, wherein the virtual beams include one or more low end beams and one or more high end beams, wherein each of the low end beams is a beam of a corresponding integer order, wherein each of the high end beams is a delay-and-sum beam;
(c) compute a linear combination of the beam-formed signals to obtain a resultant signal.

5. The system of claim 1, wherein the program instructions further configure the processor to provide the resultant signal to a communication interface for transmission.

6. The system of claim 1, wherein the set of microphones are arranged in a circular array.

7. A system comprising:
a microphone;
a speaker;
memory configured to store program instructions;
a processor configured to read and execute the program instructions from the memory, wherein the program instructions are executable by the processor to:
(a) output a stimulus signal for transmission from the speaker;
(b) receive an input signal from the microphone;
(c) compute a midrange sensitivity and a lowpass sensitivity for a spectrum of the input signal;
(d) subtract the midrange sensitivity from the lowpass sensitivity to obtain a speaker-related sensitivity;
(e) perform an iterative search for current values of parameters of an input-output model for the speaker using the input signal spectrum, a spectrum of the stimulus signal, the speaker-related sensitivity;
(f) update averages of the parameters of the speaker input-output model using the current values obtained in (e);
wherein the parameter averages of the speaker input-output model are usable to perform echo cancellation on other input signals.

8. The system of claim 7, wherein the input-output model of the speaker is a nonlinear model.

9. The system of claim 8, wherein the stimulus signal is a noise signal.

10. The system of claim 7, wherein the program instructions are executable by the processor to:
perform an iterative search for a current transfer function of the microphone using the input signal spectrum, the spectrum of the stimulus signal, and the current values;
update an average microphone transfer function using the current transfer function;
wherein the average transfer function is usable to perform said echo cancellation on said other input signals.

11. A system comprising:
a microphone;
a speaker;
memory configured to store program instructions;
a processor configured to read and execute the program instructions from the memory, wherein the program instructions are executable by the processor to:
(a) provide an output signal for transmission from the speaker, wherein the output signal carries live signal information from a remote source;
(b) receive an input signal from the microphone;
(c) compute a midrange sensitivity and a lowpass sensitivity for a spectrum of the input signal;
(d) subtract the midrange sensitivity from the lowpass sensitivity to obtain a speaker-related sensitivity;
(e) perform an iterative search for current values of parameters of an input-output model for the speaker using the input signal spectrum, a spectrum of the output signal, the speaker-related sensitivity;
(f) update averages of the parameters of the speaker input-output model using the current values obtained in (e);
wherein the parameter averages of the speaker input-output model are usable to perform echo cancellation on other input signals.

12. The system of claim 11, wherein the input-output model of the speaker is a nonlinear model.

13. The system of claim 12, wherein the nonlinear model is a Volterra series model.

14. The system of claim 11, wherein the program instructions are executable by the processor to:
perform an iterative search for a current transfer function of the microphone using the input signal spectrum, the spectrum of the output signal, and the current values;
update an average microphone transfer function using the current transfer function;
wherein the current transfer function is usable to perform said echo cancellation on said other input signals.

15. A method comprising:
(a) receiving an input signal from each microphone in set of microphones;
(b) transforming the input signals into the frequency domain to obtain respective input spectra;
(c) operating on the input spectra with a set of virtual beams to obtain respective beam-formed spectra, wherein each of the virtual beams is associated with a corresponding frequency range and a corresponding subset of the input spectra, wherein each of the virtual beams operates on portions of input spectra of the corresponding subset of input spectra which have been band limited to the corresponding frequency range, wherein the virtual beams include one or more low end beams and one or more high end beams, wherein each of the low end beams is a beam of a corresponding integer order, wherein each of the high end beams is a delay-and-sum beam;
(d) computing a linear combination of the beam-formed spectra to obtain a resultant spectrum; and
(e) inverse transforming the resultant spectrum to obtain a resultant signal.

16. The method of claim 15 further comprising:
providing the resultant signal to a communication interface for transmission.

17. The method of claim 15, wherein the set of microphones are arranged in a circular array.

18. A method comprising:
(a) receiving an input signal from each microphone in a set of microphones;
(b) operating on the input signals with a set of virtual beams to obtain respective beam-formed signals, wherein each of the virtual beams is associated with a corresponding frequency range and a corresponding subset of the input signals, wherein each of the virtual beams operates on versions of the input signals of the corresponding subset of input signals which have been band limited to the corresponding frequency range, wherein the virtual beams include one or more low end beams and one or more high end beams, wherein each of the low end beams is a beam of a corresponding integer order, wherein each of the high end beams is a delay-and-sum beam; and
(c) computing a linear combination of the beam-formed signals to obtain a resultant signal.

19. The method of claim 18 further comprising:
providing the resultant signal to a communication interface for transmission.

20. The method of claim 18, wherein the set of microphones are arranged in a circular array.

21. A method comprising:
(a) outputting a stimulus signal for transmission from a speaker;
(b) receiving an input signal from a microphone;
(c) computing a midrange sensitivity and a lowpass sensitivity for a spectrum of the input signal;
(d) subtracting the midrange sensitivity from the lowpass sensitivity to obtain a speaker-related sensitivity;
(e) performing an iterative search for current values of parameters of an input-output model for the speaker using the input signal spectrum, a spectrum of the stimulus signal, the speaker-related sensitivity;
(f) updating averages of the parameters of the speaker input-output model using the current values obtained in (e);
wherein the parameter averages of the speaker input-output model are usable to perform echo cancellation on other input signals.

22. The method of claim 21, wherein the input-output model of the speaker is a nonlinear model.

23. The method of claim 22, wherein the stimulus signal is a noise signal.

24. The method of claim 21 further comprising:
performing an iterative search for a current transfer function of the microphone using the input signal spectrum, the spectrum of the stimulus signal, and the current values;
updating an average microphone transfer function using the current transfer function;
wherein the average transfer function is usable to perform said echo cancellation on said other input signals.

25. A method comprising:
(a) providing an output signal for transmission from a speaker, wherein the output signal carries live signal information from a remote source;
(b) receiving an input signal from a microphone;
(c) computing a midrange sensitivity and a lowpass sensitivity for a spectrum of the input signal;
(d) subtracting the midrange sensitivity from the lowpass sensitivity to obtain a speaker-related sensitivity;
(e) performing an iterative search for current values of parameters of an input-output model for the speaker using the input signal spectrum, a spectrum of the output signal, the speaker-related sensitivity;
(f) updating averages of the parameters of the speaker input-output model using the current values obtained in (e);
wherein the parameter averages of the speaker input-output model are usable to perform echo cancellation on other input signals.

26. The method of claim 25, wherein the input-output model of the speaker is a nonlinear model.

27. The method of claim 26, wherein the nonlinear model is a Volterra series model.

28. The method of claim 25 further comprising:
performing an iterative search for a current transfer function of the microphone using the input signal spectrum, the spectrum of the output signal, and the current values;
updating an average microphone transfer function using the current transfer function;
wherein the current transfer function is usable to perform said echo cancellation on said other input signals.
